(19) United States
(12) Patent Application Publication
(10) Pub. No.: US 2011/0241327 A1
(43) Pub. Date: Oct. 6, 2011

(54) Rolling Bearing, Particularly for a Steering Column

(76) Inventors: Bruno Montboeuf, Cerelles (FR); Jacques Delos, Desmonts (FR)

(21) Appl. No.: 13/122,536

(22) PCT Filed: Sep. 18, 2009
(86) PCT No.: PCT/EP2009/062097

§ 371 Date: Jun. 23, 2011

(30) Foreign Application Priority Data
Oct. 2, 2008 (FR) 0856666

(51) Int. Cl. B62D 1/16; F16C 33/48; B21D 53/10

(52) U.S. Cl. 280/775; 384/572; 29/898.04

(57) ABSTRACT

The rolling bearing device comprises an outer ring (11), an inner ring (10) comprising a bore (10a) for mounting the device on a shaft, and at least one row of rolling elements (14) positioned between the rings. The bore (10a) comprises weakening means (23) that locally reduce the mechanical strength of the inner ring in respect of radial stressing. The weakening means (23) between them delimit contact surfaces where the bore (10a) makes contact with the shaft, running at least in the circumferential direction. The outer ring (11) comprises a casing, two attached raceways (12, 13) positioned in the casing, and an elastic ring (16) pressing against the casing and one of the raceways (12).

The present invention relates to the field of rolling bearings, particularly those intended for motor vehicle steering columns.

Steering columns are generally equipped with a two-part shaft, each end of the said parts being partially nested one inside the other, in order to transmit a torque. One of the shaft parts supports the driver's steering wheel and via transmission elements, for example splines, transmits the torque applied by the driver to a member for steering the wheels of the vehicle, the member being supported by the other shaft part.

Document WO 2005/015039 discloses a rolling bearing for a motor vehicle steering column shaft comprising an outer ring, an inner ring, and a plurality of balls provided between the rings, in which bearing the inner ring comprises a bore provided with catching teeth of V-shaped cross section, the tips of which teeth, at the time of assembly, are crushed against the steering column shaft in order to secure the bearing rigidly thereto.

Also disclosed, in document JP-A-02182575, is a steering column comprising a shaft mounted such that it can rotate inside a supporting housing via two rolling bearings. One of these bearings is made of a material that is elastically deformable so that in the event of an accident some of the impact of the driver's chest against the steering wheel of the vehicle can be absorbed if necessary.

This solution has the major disadvantages of not providing effective absorption in the event of a violent frontal impact and of not being able to limit the movement of the steering column towards the driver in such an impact, thereby potentially giving rise to significant damage to the driver's chest.

To remedy these disadvantages, steering columns are generally equipped with a shaft comprising two telescopic parts so that in the event of an accident one of the parts of the shaft can slide relative to the other, thus preventing the steering column from moving towards the driver.

To this end, document GB-A-2 368 894 describes a steering column comprising a shaft provided with upper and lower parts nested partially one inside the other and inside a supporting housing. The upper part comprises a rolling bearing between the shaft and the supporting housing. The lower part comprises a rolling bearing positioned between the steering column shaft and a plain bearing, of tubular overall shape. The plain bearing is mounted such that it can slide in the supporting housing so as to allow its axial movement inside the said housing and the relative movement of the upper and lower parts of the shaft, in the event of an accident.

This steering column has the disadvantage of entailing the use of an additional bearing that is specially designed to be mounted such that it can slide inside the supporting housing. This increases the number of components that have to be manufactured, and assembled, and increases the cost of assembly of the steering column.

It is therefore an object of the present invention to overcome these disadvantages.

More specifically, the present invention sets out to provide a rolling bearing for a motor vehicle steering column which is of a simple design, easy to manufacture and to assemble, and makes it possible to prevent the said column from moving towards the driver in the event of a frontal impact.

In one embodiment, the rolling bearing device comprises an outer ring, an inner ring comprising a bore for mounting the device on a shaft, and at least one row of rolling elements positioned between the rings. The bore comprises weakening means that locally reduce the mechanical strength of the inner ring in respect of radial stressing. The weakening means between them delimit contact surfaces where the bore makes contact with the shaft, running at least in the circumferential direction. The outer ring comprises a casing, two attached raceways positioned in the casing, and an elastic ring pressing against the casing and one of the raceways.

Mounting the bearing on the associated shaft, for example on the shaft of a steering column, is made easier in so far as, even if there is a spread on the tolerances on the exterior surface of this shaft, the weakening means that locally reduce the mechanical strength of the inner ring make it easier for the said ring to be deformed radially at the time of mounting on the shaft, making it easier to fit.

Given this capacity for radial deformation of the inner ring, it is possible to provide a larger diametral dimension for the inner ring of the rolling bearing than is conventionally the case, while at the same time ensuring that, at the time of fitting, there is enough interference between the inner ring and the shaft to prevent any relative movement of these two elements during operation under normal conditions.

However, because the interference between the inner ring of the rolling bearing and the associated shaft remains relatively slight, in the event of the vehicle being involved in a frontal impact, this interference is not enough to maintain the relative axial positioning of the rolling bearing and of the steering column shaft. As a result, a first part of the shaft can slide relative to a second part of the said shaft in such a way as to prevent the steering column from moving towards the driver. This then prevents the steering column from moving towards the driver's chest.

The weakening means advantageously comprise local cavities. In one embodiment, the weakening means comprise grooves. The grooves preferably run axially along the bore, and may be spaced apart uniformly in the circumferential direction. The grooves are advantageously identical.

Advantageously, the circumferential dimension of the cavities ranges between 1 and 6% of the circumferential dimension of the bore of the inner ring and preferably ranges between 2 and 4%.

In one embodiment, the ratio between the depth of the cavities and the thickness of the inner ring ranges between 1 and 10% and preferably ranges between 3 and 7%.

As a preference, the ratio between the overall contact surface where the bore makes contact with the exterior surface of the shaft, and the said exterior surface ranges between 40 and 60%.

In one embodiment, the circumferential dimension of each contact surface where the bore makes contact with the shaft is at least equal to the circumferential dimension of a cavity.

In one embodiment, a steering column comprises a two-part shaft, the two parts being angularly connected by their end, one of which fits inside the other, and two rolling bearings each mounted on one of the parts of the shaft and comprising an outer ring, an inner ring comprising a bore for the passage of the associated shaft part, and at least one row of rolling elements positioned between the rings. The bore of at least one of the inner rings comprises weakening means that locally reduce the mechanical strength of the inner ring in respect of radial stressing. The weakening means between them delimit contact surfaces where the bore makes contact with the shaft, running at least in the circumferential direction. The outer ring of the said rolling bearing comprises a casing, two attached raceways positioned in the casing, and an elastic ring pressing against the casing and one of the raceways.

The invention further relates to a method of manufacturing an inner ring of a rolling bearing of the type comprising an outer ring, the inner ring and at least one row of rolling elements positioned between the rings, in which a tube is formed from a bar or from a blank, the tube is passed through a sizing die to form a bore comprising weakening means that locally reduce the mechanical strength of the tube in respect of radial stressing which between them delimit surfaces running at least in the circumferential direction, then the tube is cut to the desired length in order to obtain the inner ring of the rolling bearing.

The present invention will be better understood from reading the detailed description of an exemplary embodiment taken by way of entirely nonlimiting example and illustrated by the attached drawings, in which:

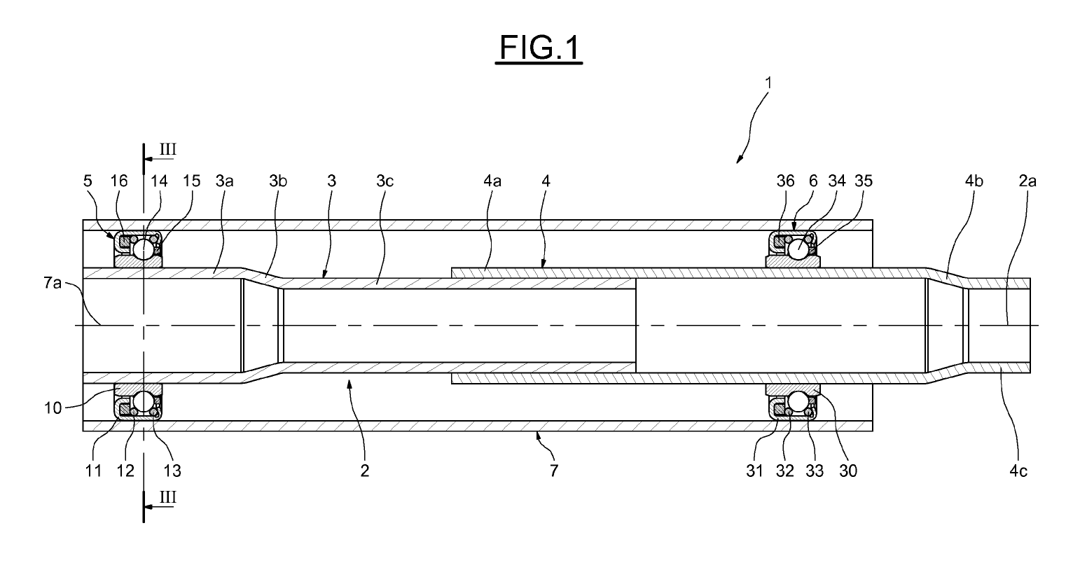

FIG. 1 is a schematic view in axial section of a steering column comprising rolling bearings according to the invention;

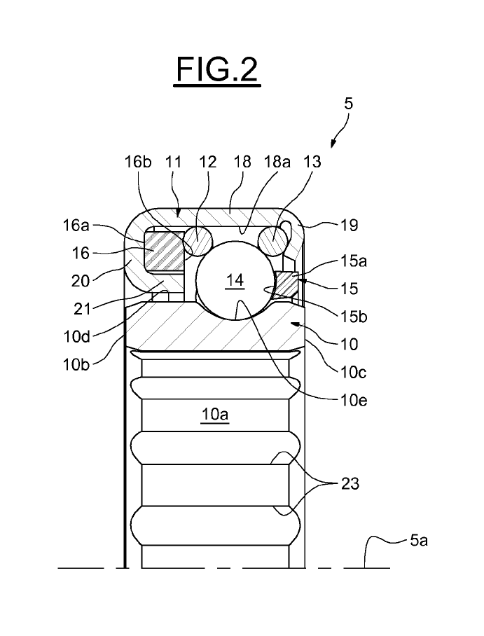

FIG. 2 is a half view in axial section of one of the rolling bearings of FIG. 1;

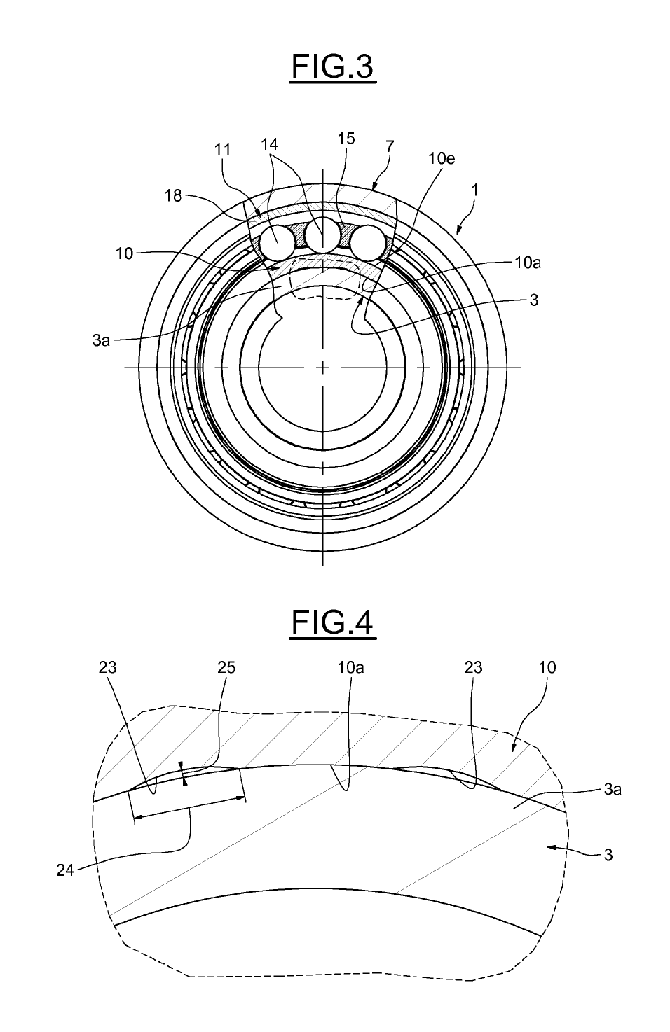

FIG. 3 is a view in section on III-III of FIG. 1; and

FIG. 4 is a detail of FIG. 3.

As may be seen in FIG. 1, the steering column, referenced 1 overall, comprises a tubular shaft 2 of axis 2a provided with first and second nested coaxial parts 3, 4, two rolling bearings 5, 6 mounted on the first and second parts 3, 4, respectively, and a tubular steering column housing 7 in which the rolling bearings 5, 6 are mounted. The axis 7a of the housing 7 coincides with the axis 2a of the shaft 2.

The first part 3 of the shaft 2 runs axially along the axis 2a and comprises, at a lower end, an axial portion 3a on which the rolling bearing 5 is mounted. The axial portion 3a is extended, from an upper end, by an inwardly directed frustoconical portion 3b itself extended by an axial portion 3c. Part of the axial portion 3c is mounted inside a large-diameter axial portion 4a of the second part 4 of the shaft 2. The axial portion 4a is extended, from an upper end, by a smaller-diameter axial portion 4c via a frustoconical portion 4b. The rolling bearing 6 is, in this instance, mounted on the axial portion 4a.

The first part 3 and the second part 4 of the shaft 2 are connected angularly to one another by rotational-drive elements, for example splines (not depicted). These splines may run axially along the part of the axial portion 3c mounted inside the axial portion 4a and collaborate with correspondingly shaped housings of the said portion 4a, so as to be able to transmit to a system for steering the wheels of the vehicle (not depicted), the movement and torque applied by a driver via a steering wheel (not depicted). The system is supported by the axial portion 3a, the steering wheel for its part being supported by the axial portion 4c.

As illustrated more clearly in FIG. 2, the rolling bearing 5, the axis 5a of which coincides with the axis 7a (FIG. 1), comprises an inner ring 10 mounted directly on the steering column part 3, an outer ring 11 forced inside the housing 7, two attached raceways 12 and 13 in the form of wires, a row of rolling elements 14 in this instance produced in the form of balls, a cage 15 to maintain the uniform circumferential spacing of the rolling elements 14, and an elastic ring 16.

The inner ring 10 comprises a bore 10a of cylindrical overall shape delimited by radial frontal surfaces 10b and 10c, and an exterior cylindrical surface 10d in which there is formed a toroidal circular channel 10e which, in cross section, has a concave internal profile able to form a raceway for the rolling elements 14, the said channel being directed outward. The channel 10e is offset axially towards the radial surface 10c with respect to a radial mid-plane of the inner ring 10.

As will be described in greater detail later, the inner ring 10 of the rolling bearing 5 is designed to allow it to be fitted easily onto the part 3 of the shaft 2, and to allow this part 3 to slide inside the part 4 of the said shaft in the event of a frontal impact so as to prevent the steering column 1 from moving towards the driver.

The outer ring 11 is produced in the form of a casing, of an annular shape with an overall U-shaped cross section, comprising an axial portion 18 extended at each end by a radial portion 19, 20. The radial portion 19 has a thickness less than the thickness of the axial portion 18 and of the radial portion 20, and a length in the radial direction less than the length of the radial portion 20. In other words, the space separating the radial portion 19 from the exterior cylindrical surface 10d is greater than the space separating the said surface from the radial portion 20.

The radial portion 20 is extended, from a small-diameter edge, by a short axial portion 21 running axially in the direction of the rolling elements 14 while at the same time remaining distant therefrom. The axial portion 21 is designed to centre the elastic ring 16 inside the rolling bearing 5.

The attached raceways 12 and 13 are in the form of annular snap rings and are positioned in the outer ring 11 in direct contact therewith. The attached raceways 12 and 13 are formed of rolled wires, the ends of which butt together when the snap rings are fitted into the outer ring 11. As an alternative, it might also be conceivable to provide attached raceways 12, 13 in the form of circumferentially continuous annuli which, in a cross section passing through the axis 5a of the rolling bearing 5, exhibit arc-shaped cavities of a radius substantially equal to the radii of the rolling elements 14. The raceway 12 is arranged in contact with the bore 18a of the axial portion 18 and in contact with the radial portion 20 via the elastic ring 16. The raceway 13 is arranged in contact with the bore 18a and the radial wall 19. The rolling elements 14 are positioned between the raceways 12 and 13 of the outer ring 11, and the channel 10e of the inner ring 10 that forms the raceway. This then yields a rolling bearing with three points of contact.

The retaining cage 15 comprises an annular portion 15a positioned axially on the same side as the radial portion 19, and radially between the free end of the said radial portion 19 and the cylindrical surface 10d of the inner ring 10. The cage 15 also comprises cells 15b that house the rolling elements 14 in order to maintain the uniform circumferential spacing thereof.

The elastic ring 16 is in the form of a torus that is continuous in the circumferential direction. The ring 16 is positioned in contact with the radial portion 20 and the raceway 12. The elastic ring 16 is positioned radially between the axial portions 18 and 21, remaining a distance away therefrom. More specifically, a radial surface 16a of the ring 16 is in contact with an internal face of the radial portion 20, and an opposite radial surface 16b is in contact with the raceway 12. The radial surface 16b of the ring 16 is axially offset outward with respect to the rolling elements 14 and radially inward with respect to the bore 18a of the axial portion 18. In other words, the elastic ring 16 is dimensioned in such a way as to remain spaced or at a distance away from the rolling elements 14. In the embodiment illustrated, the elastic ring 16 is in the form of a torus of square cross section. As an alternative, it might be possible to envisage an elastic ring that had a different profile, for example a circular profile, in cross section.

At the point of contact between the attached raceway 12 and the elastic ring 16, the latter exerts a permanent axial preload on the attached raceway 12. Through this axial load, the elastic ring 16 has a tendency, via the attached raceway 12, to push and preload the row of rolling elements 14 against the attached second raceway 13, and also against the channel 10e of the inner ring 10. The load applied therefore prestresses the rolling elements 14 against the channel 10e and the raceway 13. This load therefore makes it possible to take up any internal axial play that may exist. This axial load also tends to push the attached raceway 12 towards the bore 18a of the axial portion 18 of the outer ring 11, via the rolling elements 14. The elastic ring 16 also makes it possible to eliminate any radial play that might be between the outer ring 11 and the raceway 12. The elastic ring 16 thus makes it possible to always maintain a preload in the rolling bearing 5.

At its bore 10a, the inner ring comprises a plurality of axial grooves 23 spaced apart from one another uniformly in the circumferential direction. The grooves 23 are identical to one another and run axially along the bore 10a so that they come into close proximity with the radial surfaces 10b and 10c. As an alternative, it might be possible to envisage grooves 23 that opened onto these surfaces.

As illustrated more visibly in FIG. 4, each groove 23 in cross section has a concave internal profile in the shape of an arc of a circle directed towards the exterior surface of the axial portion 3a of the part 3 of the steering column shaft.

Advantageously, the circumferential dimension of the grooves 23, illustrated schematically by the arrow 24, ranges between 1 and 6% of the circumferential dimension of the bore 10a of the internal ring 10, and preferably ranges between 2 and 4%. The ratio between the depth of the grooves 23 as illustrated by the arrow 25 and the thickness of the inner ring 10 advantageously for its part ranges between 1 and 10%, and preferably ranges between 3 and 7%.

For example, for an inner ring 10 diameter of 21.85 mm, the circumferential dimension of the grooves 23 may be equal to 2 mm, and the depth equal to 0.15 mm. For such a diameter, it is possible to provide a number of grooves 23 ranging between fourteen and eighteen, and preferably equal to sixteen.

The grooves 23 delimit, in the circumferential direction of the bore 10a, contact zones or contact surfaces where the inner ring 10 makes contact with the part 3 of the shaft 2 running axially and circumferentially and zones that remain a distance away from the said part 3. The contact zones where the inner ring 10 makes contact with the part 3 of the steering column shaft are uniformly spaced in the circumferential direction. There is therefore a uniform alternation in the circumferential direction on the bore 10a between a plain zone, i.e. a zone with no projections, in direct contact with the exterior surface of the part 3 of the steering column shaft, and a zone that remains spaced away from the said part 3. The circumferential dimension of the contact zones or contact surfaces is at least equal to the circumferential dimension of the grooves 23. The overall contact surface where the inner ring 10 and the part 3 of the steering column shaft make contact is limited. Advantageously, the ratio between the overall contact surface where the bore 10a makes contact with the exterior surface of the part 3, and the said exterior surface ranges between 40 and 60%.

The grooves 23 formed on the bore 10a of the inner ring locally form weakening means that reduce the mechanical strength of the said ring in respect of radial stressing, making it easier to deform in the radial direction when the rolling bearing 5 is being mounted on the shaft 2 of the steering column. In that way it becomes possible to compensate for any spread on the manufacturing tolerances on the part 3 of the steering column shaft 2 and any irregularities in shape, such as ovalization, triangularization, etc.

Given this capacity for radial deformation of the inner ring 10, it may be possible to envisage a larger diametral dimension than is generally the case for the bore 10a. Thus, the magnitude of the tight fit achieved between the internal ring 11 and the part 3 may be reduced. The ratio between the interference on the diameter of the bore 10a of the inner ring 10 and the outer diameter of the part 3 may advantageously range between 0.02 and 0.1%. For example, the diameter of the bore 10a may be 21.85 mm with a tolerance of +/−0.05, and the diameter of the shaft may be 22 mm with a tolerance of 0/−0.084.

This then limits the tightness of the inner ring on the part 3 under conditions that are sufficient to ensure that the rolling bearing 5 and the part 3 of the shaft 2 nevertheless maintain their relative axial positioning under normal operating conditions, while at the same time allowing relative axial movement of these two elements in the event of a frontal impact of the vehicle so that the part 3 can slide inside the part 4 of the steering column shaft 2.

Furthermore, the grooves 23 also form means of limiting a torque transmitted between the inner ring 11 and the part 3. Specifically, when this torque becomes abnormally high, given the slight amount of clamping between the inner ring 10 and the part 3 that can be envisaged on account of the grooves 23, these two elements slip relative to one another in the circumferential direction.

By virtue of the grooves 23, the rolling bearing 5 can easily be fitted onto and removed from the part 3 of the steering column shaft 2 given that a looser fit between the internal ring 10 and the part 3 may be envisaged. For example, the pulling force needed to remove the rolling bearing 5 from the shaft 2 ranges between 1 and 3 kN. This then reduces the time and cost involved in assembling and dismantling the steering column.

Moreover, the rolling bearing 5 makes it possible, in the event of a frontal impact, for the part 3 to slide inside the part 4 of the steering column shaft 2 without the need to provide additional parts at the inner ring 10, or alternatively at the supporting housing 7. This then maintains a limited number of components.

In the embodiment illustrated in the figures, the means that allow local weakening of the mechanical strength of the internal ring 10 in the radial direction are produced in the form of axial grooves 23. However, it will be appreciated that it might be possible to provide other types of cavity in order to allow radial deformation of the inner ring 10 under the effect of radial stressing. It may, for example, be possible to provide cavities produced in the form of a plurality of concavities or recessed dishes arranged in axial rows offset from one another in the circumferential direction.

However, the provision of local cavities in the form of axial grooves is particularly advantageous for the manufacture of the inner ring 10 because in order to manufacture this ring, the first step is to form a tube from a bar or from a blank, then the tube is passed through a sizing die to form the bore 10a including the grooves 23. Finally, the tube is cut to the desired length in order to obtain the desired axial dimension of the inner ring 10. Thus there is no need to envisage any operations of grinding the bore 10a, which operations are generally lengthy and expensive.

With reference once again to FIG. 1, the rolling bearing 6, which is identical to the rolling bearing 5, comprises an inner ring 30 mounted directly on the part 4 of the steering column, an outer ring 31 pushed into the supporting housing 7, two attached raceways 32 and 33 in the form of wires, a row of rolling elements 34 here produced in the form of balls, a cage 35 for maintaining the uniform circumferential spacing of the rolling elements 34, and an elastic ring 36. The inner ring 30 of the rolling bearing 6 comprises grooves identical to those formed in the bore 10a of the inner ring 10 of the bearing 5.

As an alternative, it might, however, be possible to use a rolling bearing 6 that has no such grooves on the bore of the inner ring 10 insofar as the rolling bearing 5 may already allow the part 3 to slide inside the part 4 of the steering column shaft in the event of a frontal impact in order to prevent the steering column 1 from moving towards the driver.

1. A rolling bearing device comprising:
an outer ring including a casing, two raceway members disposed in the casing, and an elastic ring disposed between the casing and one of the raceway members,
an inner ring having a bore for mounting the device on a shaft and including weakening means for locally reducing mechanical strength of the inner ring with respect to radial stress and circumferential contact surfaces for contacting the shaft defined in the bore between the weakening means, and
at least one row of rolling elements positioned between the rings.

2. The device according to claim 1, wherein the weakening means include cavities.

3. The device according to claim 1, wherein the weakening means include grooves.

4. The device according to claim 3, wherein the grooves extend generally axially along the bore.

5. The device according to claim 3, wherein the grooves are generally uniformly spaced in the circumferential direction.

6. The device according to claim 2, wherein a circumferential dimension of each cavity is between 1% and 6% of a circumferential dimension of the bore.

7. The device according to claim 2, wherein a ratio between a depth of each cavity and a thickness of the inner ring is between 1% and 10%.

8. The device according to claim 2, wherein a circumferential dimension of each contact surface is one of equal to and greater than a circumferential dimension of each cavity.

9. The device according to claim 1, wherein each contact surface has a circumferential dimension and a ratio between the sum of the circumferential dimensions of all the contact surfaces and a circumferential dimension of the shaft is between 40% and 60%.

10. A steering column comprising:
a shaft including two parts angularly connected by an end of one of the two parts being disposed within an end of the other one of the two parts, and
two rolling bearings each mounted on one of the parts of the shaft and including an outer ring including a casing, two raceway members disposed in the casing, and an elastic ring disposed between the casing and one of the raceway members, an inner ring having a bore for mounting the device on a shaft and including weakening means for locally reducing mechanical strength of the inner ring with respect to radial stress and circumferential contact surfaces for contacting the shaft defined in the bore between the weakening means, and at least one row of rolling elements positioned between the rings.

11. A method of manufacturing an inner ring of a rolling bearing, the method comprising the steps of:
providing one of a bar or blank
forming a tube from the one of the bar and the blank,
passing the tube through a sizing die to form a bore including weakening means for locally reducing the mechanical strength of the tube with respect to radial stress and circumferential contact surfaces defined between the weakening means, and
cutting the tube to a desired length in order to obtain the inner ring of the rolling bearing.
